(19) United States
(12) Patent Application Publication
(10) Pub. No.: US 2012/0006483 A1
(43) Pub. Date: Jan. 12, 2012

(54) Methods for Interconnecting Solar Cells

(75) Inventors: Jack I. Hanoka, Brookline, MA (US); Peter F. Vandermeulen, Newburyport, MA (US)

(73) Assignee: 7AC Technologies, Inc., Woburn, MA (US)

(21) Appl. No.: 12/984,831

(22) Filed: Jan. 5, 2011

Related U.S. Application Data
(60) Provisional application No. 61/360,587, filed on Jul. 1, 2010.

(51) Int. Cl. B32B 37/12; B23K 31/02; B32B 37/02

(52) U.S. Cl. 156/327; 156/60; 228/180.5

(57) ABSTRACT

Methods for interconnecting solar cells to form solar cell modules are disclosed. The methods utilize a non-EVA polymer as the encapsulant and the temperature and pressure conditions of a lamination process to effect interconnection.

### CROSS REFERENCE TO RELATED APPLICATION

This application claims priority from U.S. Provisional Patent Application Ser. No. 61/360,587, filed on Jul. 1, 2010, entitled METHODS FOR INTERCONNECTING SOLAR CELLS, which is hereby incorporated by reference.

### BACKGROUND

The present application generally relates to photovoltaic modules and hybrid “PVT” modules (modules that combine photovoltaics and thermal generation) containing a plurality of solar cells. The application is more particularly directed to methods to facilitate and lower the cost of interconnecting the solar cells in such devices.

The front metallization pattern for typical crystalline silicon solar cells comprises a large number of very thin fingers (or other conductive structures such as spider-shaped conductors) and two or three busbars, all usually formed using a silver containing paste that is fired into the silicon to form an ohmic contact. The busbars are wide strips that provide surfaces for bonding to interconnecting wires. A typical solar cell 100 with two busbars 102 is shown in FIG. 1.

The interconnecting wires are usually flat, approximately 2 mm wide, and are either tin plated copper or tin-silver plated copper. The typical rear side metallization pattern is aluminum all over the surface of the back of the solar cell with either islands or strips of a non-aluminum material that allow for soldering. The reason for this is that aluminum itself cannot generally be soldered using conventional techniques. The interconnecting wires are bonded to the cells along the busbars on the front of the cells using solder that is heated to temperatures on the order of 200 degrees Celsius and higher. These wires are usually about twice the length of the solar cell and the parts of the wires not attached to the front of the cell are soldered to the rear of an adjacent cell. In this way each cell is connected in series to adjacent cells, front to back, front to back, etc. A string of such cells is thus formed. These strings are then brought to a lay-up machine where they are connected either in series or in parallel to form whatever the desired voltage of the PV module is. FIG. 2 is a simplified illustration of a cell string 200 comprising three crystalline silicon solar cells 100 and metal interconnecting wires 202 or ribbons as it is often termed. Following the interconnection step, the cell strings are deployed as follows. First, the front glass is covered with a sheet of ethylene vinyl acetate (EVA), which is the most widely used encapsulant for crystalline silicon solar cells.

Then, the cell strings are laid out onto this sheet of EVA. The cell strings are then wired together to form the desired series and parallel connections using a wider metallic strip about 1 cm in width. Another sheet of encapsulant is placed over the interconnected cell strings. This could be a separate sheet of EVA or it could be bonded as a laminate to backskin material. An example of a finished crystalline silicon solar cell module 300 is shown in FIG. 3. In this example, there are six series connected strings of eight cells each. Each cell has three busbars, which are shown as faint light lines running vertically.

Because of all the handling and thermal requirements needed to be able to effect the front-to-back soldering operation described above, this interconnect process can result in considerable stress on the solar cells. This is especially true for the thin cells that are the norm now. Such cells are anywhere from about 150 to 200 microns in thickness. As the industry pushes for even thinner cells (less than 150 microns in thickness), this issue will clearly become even more acute. As a result, the process can cause cracked cells that are at nearly the end of the value chain in manufacturing, resulting in a greater penalty in yield and value lost. Furthermore, the equipment used to perform this process is expensive and capital expenditures are now a major concern as the industry tries to expand while module prices continue their downward trend.

Silicon solar cells are thin and brittle and the handling required in this interconnection step as well as the thermal stresses that could be induced from the soldering process itself can lead to cracks and breakage of the cells in a step where considerable value as already been added to the manufacture of the solar cell. It would accordingly be desirable to obviate the need for conventional soldering in manufacturing solar cell modules.

### BRIEF SUMMARY OF EMBODIMENTS OF THE INVENTION

In accordance with one or more embodiments, a method is provided for electrically interconnecting solar cells in a solar module. The method includes the steps of: (a) providing a plurality of solar cells; (b) providing an upper preform and a lower preform, each comprising a sheet of ionomer encapsulant material having wires to be used for interconnecting the solar cells, said wires being bonded to an inner surface of each preform; (c) positioning the solar cells between the inner surfaces of the upper and lower preforms such that each wire on a preform includes a portion proximal to a contact area on one of the solar cells and another portion proximal to a contact area of a wire on the other preform; and (d) laminating the upper and lower preforms together such that each wire become securely connected to another wire and to a solar cell at respective contact areas to electrically interconnect adjacent solar cells.

In accordance with one or more further embodiments, a method is provided for electrically interconnecting solar cells in a solar module. The method includes the steps of: (a) providing a plurality of back-contacted solar cells; (b) providing an upper preform and a lower preform, each comprising a sheet of ionomer encapsulant material, wherein the lower preform includes wires to be used for interconnecting the solar cells, said wires being bonded to an inner surface of the lower preform; (c) positioning the solar cells between the upper and lower preforms such that each wire on the lower preform includes a portion proximal to a contact area on a back surface of one of the solar cells and another portion proximal to a contact area on a back surface of an adjacent solar cell; and (d) laminating the upper and lower preforms together such that each wire become securely connected to a solar cell and an adjacent solar cell at respective contact areas to electrically interconnect the solar cells.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a perspective view of an exemplary solar cell.

FIG. 2 is a simplified cross-sectional view of a string of solar cells connected by interconnecting wires.

FIG. 3 is a perspective view of an exemplary solar cell module.

FIGS. 4A-4C are top views of preforms in accordance with one or more embodiments.

FIG. 5A is a simplified cross-sectional view illustrating a lamination process in accordance with the prior art.

FIG. 5B is a simplified cross-sectional view illustrating a lamination process in accordance with one or more embodiments.

FIG. 6 is a simplified cross-sectional view illustrating use of a light capturing ribbon in a solar module.

FIG. 7 is a perspective view of a solar cell utilizing a light capturing ribbon in accordance with one or more embodiments.

FIG. 8 is a simplified illustration of an example of a radial finger front-side contact structure.

FIG. 9 is a simplified illustration of an example of a rectangular front-side contact structure.

FIG. 10 is a simplified illustration of conventional solar cell lamination layers.

FIG. 11 is a simplified illustration of an exemplary lamination setup in accordance with one or more embodiments using backside contact solar cells wherein the cells have interdigitated edge contacts.

FIG. 12 is a simplified illustration of an exemplary lamination setup in accordance with one or more embodiments using backside contacts wherein the backside contacts are in an island pattern.

FIG. 13 is a simplified illustration of an exemplary lamination setup in accordance with one or more embodiments using backside contacts wherein the solar cells have island-shaped contacts at the rear of the cells.

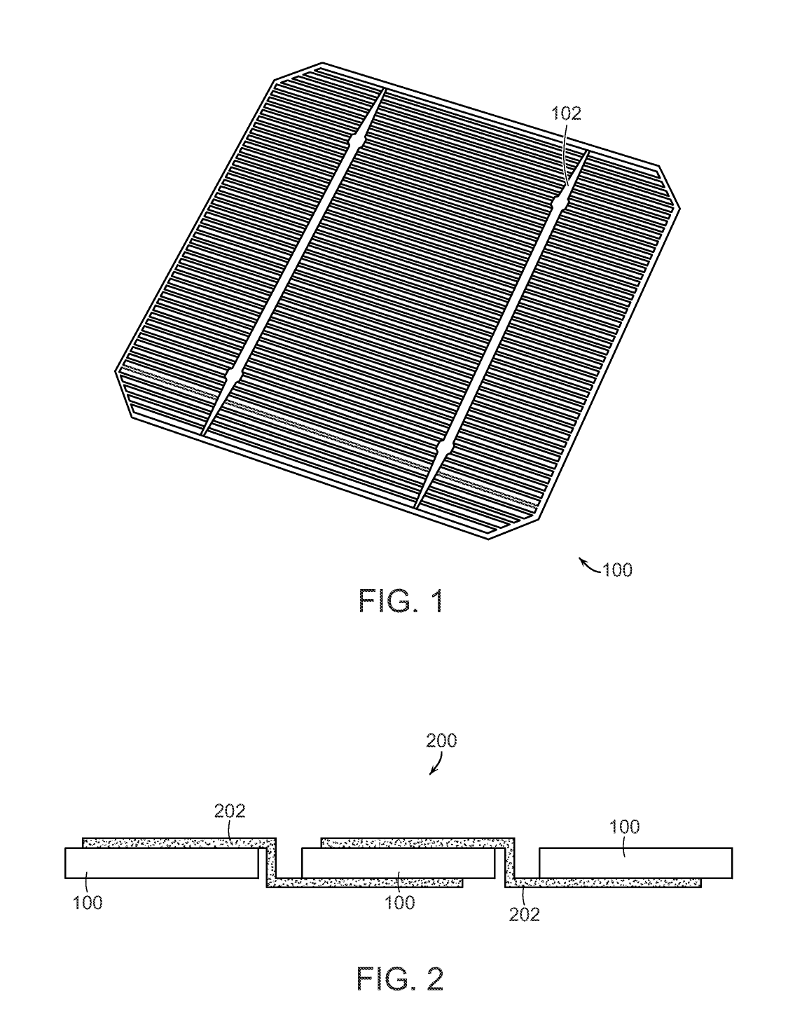

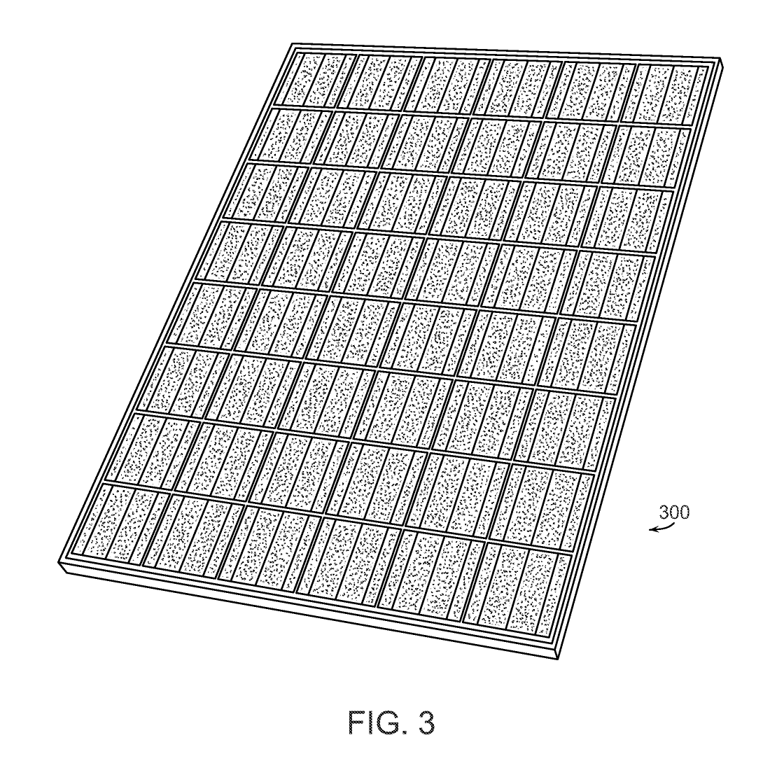

### DETAILED DESCRIPTION

In accordance with one or more embodiments, methods are provided for interconnecting solar cells that do not involve conventional soldering processes. The methods utilize a non-EVA encapsulant that has markedly different properties than EVA. The method can also utilize the conventional temperature and pressure conditions of a lamination procedure to effect the interconnection.

By itself, without any cross-linking, EVA melts at a relatively low temperature—below about 80 degrees Celsius and it flows quite readily at such temperatures. In order to be useful, it must be cross-linked. To cross-link it and turn it into a thermoset instead of a thermoplastic, an organic peroxide is added to it during the extrusion process. During the lamination process, the cross-linking itself occurs at somewhere in the neighborhood of 110-120 degrees Celsius.

The encapsulant material utilized in accordance with one or more embodiments does not require the addition of an organic peroxide to provide cross-linking. Instead, it has a type of built-in cross-linking. This built-in cross-linking is the result of ionic bonds within the material as well as the usual carbon—hydrogen covalent bonds that are found in typical hydrocarbon polymers. The material is termed ionomer. It is a copolymer of polyethylene and either methacryclic or acrylic acid. The acid is neutralized by the addition of salts containing cations such as Zn, Li, Na, and Mg. The usual polymer chains comprising carbon—hydrogen bonds are cross-linked by the ionic entities that are attached to these chains. These entities bond to similar such entities attached to other carbon hydrogen chains and form ionic bonds in doing so. This ionic bonding provides for this so-called built-in cross linking. Ionomer is already a commercially utilized encapsulant for some crystalline silicon modules and is widely used for thin film modules. Ionomer has two unique properties that are exploited in various embodiments. The material is always a thermoplastic. Even after being melted and cooled from being molten, it is still cross-linked but remains a thermo plastic not a thermoset. (EVA, on the other hand, becomes a thermoset after it is cross linked.) In fact, the cross-linking of ionomer is present to some degree even during melting. This then leads to another unique property: ionomer has unusually high melt strength even when it is molten. In this respect, it is very different from EVA, which does not have high melt strength. By exploiting this property of high melt strength, ionomer can be used to initially form an interconnect pattern with the flat wires or ribbons used for this at basically room temperature.

The high melt strength means that the spatial orientation between the wires that are originally attached to the ionomer and their relative positions will generally not be changed even if the melting temperature of the ionomer is reached. The conventional interconnection wires can be easily attached to the ionomer at room temperature by slightly heating the wires as they are tacked onto the ionomer. In the laboratory, this is readily performed using a soldering iron with a small tip and set for a low temperature. In volume production, this can easily be done by the manufacturer of the ionomer in a conventional bonding process.

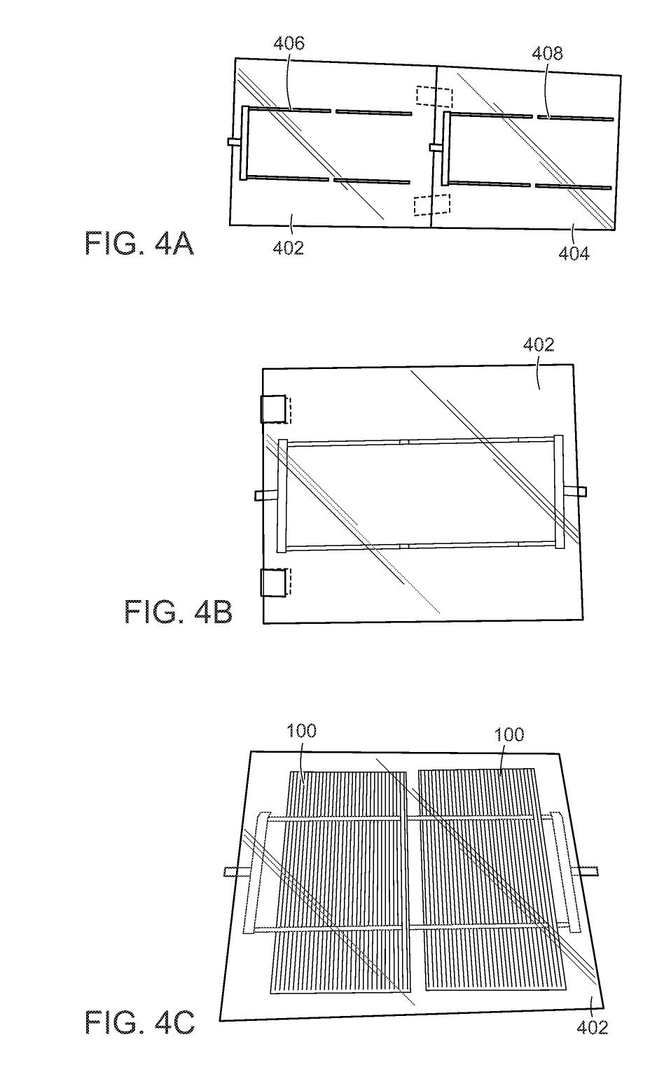

Ionomer can be used to make “preforms” for interconnection. A preform is a sheet of ionomer that already has half the interconnect wires bonded to it. To be able to actually effect interconnection, two such preform sheets of ionomer are used: one for contacting the front of the solar cells and one for contacting the back of the cells. This is illustrated by way of example in FIGS. 4A-4C. FIG. 4A shows one example of top and bottom preforms 402, 404 folded open so that solar cells can be placed in between. FIG. 4B shows the two preforms closed (for purposes of illustration without solar panels therebetween). There is room for two cells 100 in this configuration and the deployment of two cells on the bottom preform (with the top preform over them) is shown in FIG. 4C.

The next step in the solar cell interconnect method involves connecting the two sets of wires—those on the top preform 406 and those on the bottom preform 408. Methods in accordance with embodiments for achieving wire connections utilize the temperature and pressure conditions that accompany a lamination process.

In the exemplary lamination process, the preform/solar cell assembly described above (e.g., as shown in FIG. 4C), along with a glass cover for the solar module underneath is placed in a laminator and then evacuated. The peak temperature of the laminator is usually about 150 degrees Celsius. Prior to reaching this temperature, a silicone bladder is brought down on the entire assembly and produces pressure of about 14.7 psi all over the laminate assembly. This entire process can be done within 15 minutes. The module is then removed. It can be removed while still somewhat hot and allowed to cool external to the laminator. In the same way, the laminator can be kept hot, even before the assembly in placed in it. Two notable parts of the process here are the peak temperature of 150 degrees Celsius and the pressure that can be applied to the assembly. Two exemplary methods of interconnection are now described.

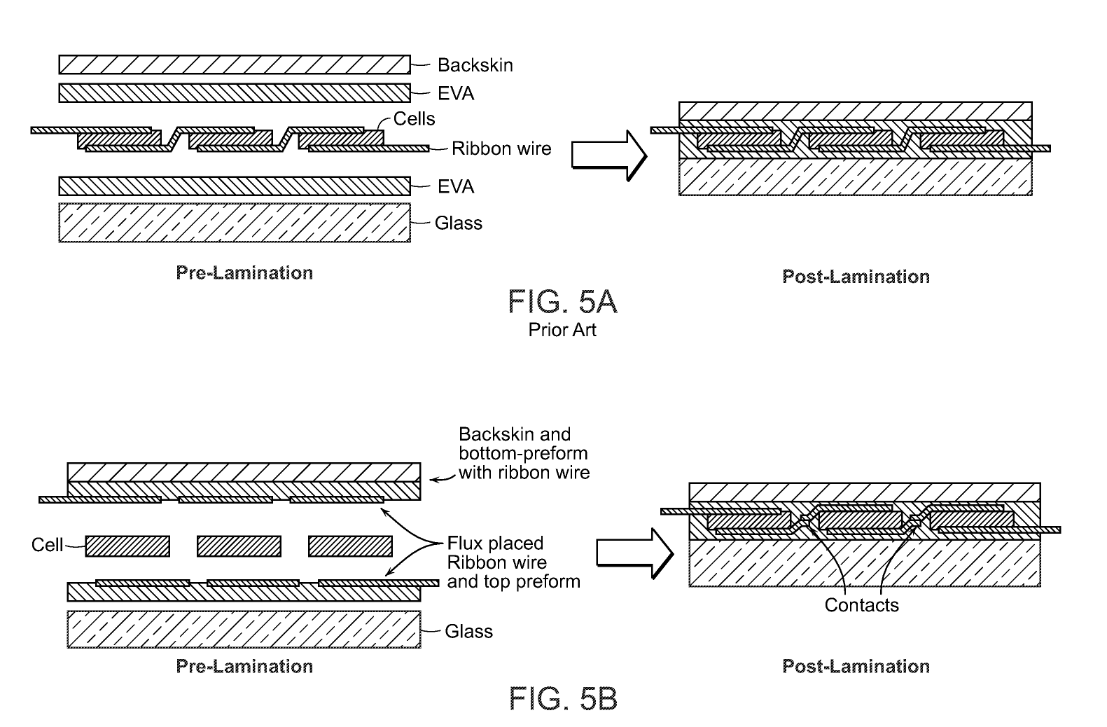

Method 1: The typical lamination cycle involves reaching a peak temperature of about 150 degrees Celsius. There are commercially available solder pastes that can do soldering at such a temperature. Ordinary solders generally require temperatures of about 200 degrees Celsius and higher. But, bismuth containing solders work at temperatures of about 140 degrees Celsius. The process proceeds as follows. The appropriate wires are attached to the ionomer preform (as discussed above) and then coated with a bismuth solder paste. The solar cells are then positioned on the lower sheet of the preform, and then the entire assembly is placed in the laminator. The temperature and pressure of the laminator are exploited to bring about the interconnection. The pressure of the laminator generally insures that the solder paste coated wires on the preforms come in direct contact with the busbars on the front of each solar cell and on the rear contact patterns. Additionally, the two sets of wires on the top preform and on the bottom preform interconnect at the points shown in FIG. 5B. For contrast, FIG. 5A shows the conventional interconnect process.

Method 2: This process is similar to Method 1 discussed above. The major difference is the use of a special type of conductive adhesive. There are silver filled conductive adhesives that are polymer based and that generally set at the lamination temperatures and form a permanent conducting connection. Unlike conventional conductive epoxies, however, they are based on a silver filled polymer that melts at temperatures less than 140 degrees Celsius. They can be supplied as “b stage” material. This means that they can be easily handled and applied at room temperature. The silver filled adhesive is coated on the wires after they had been tacked onto the ionomer sheets to form the preforms.

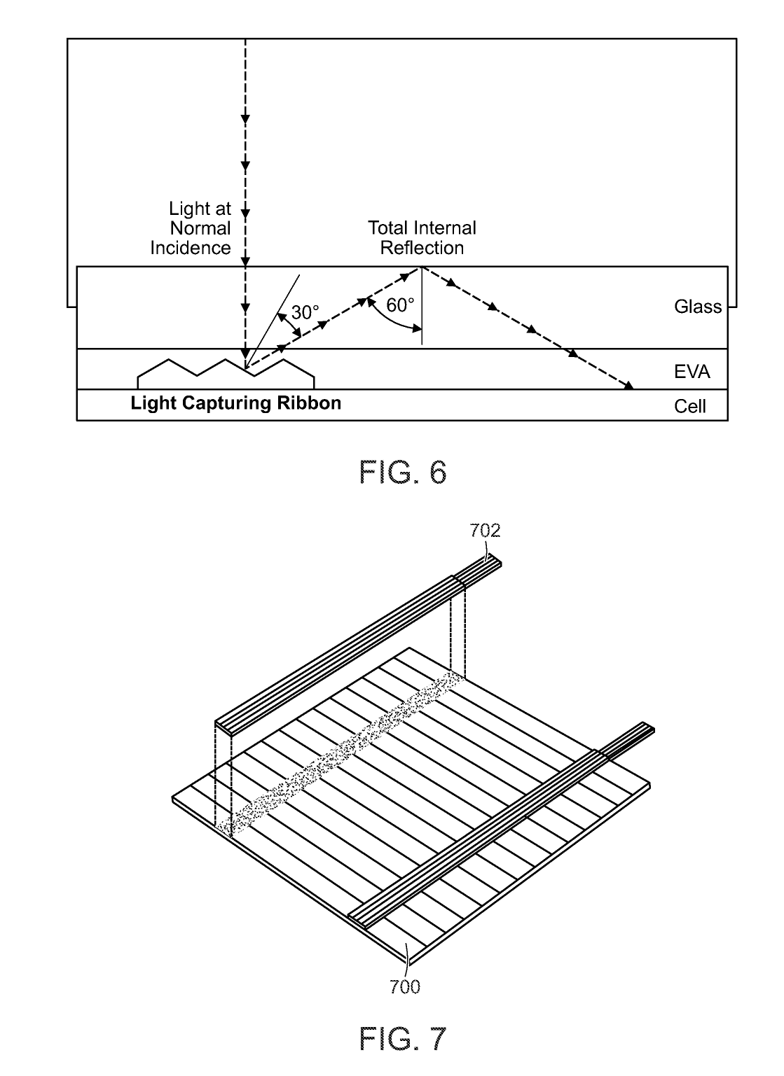

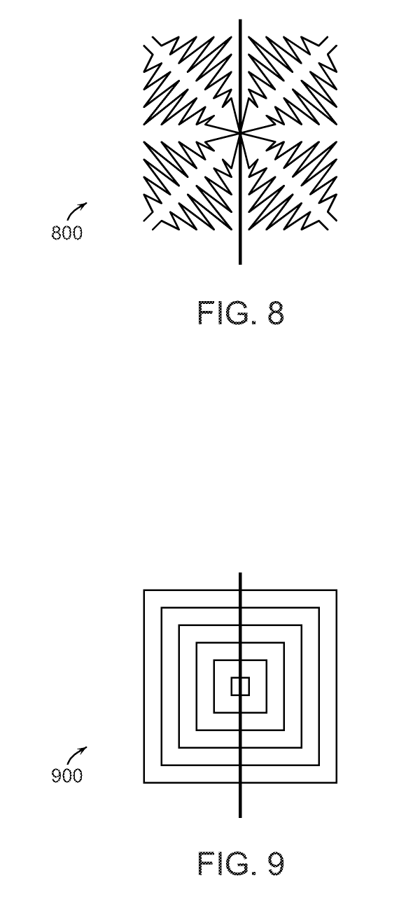

In accordance with one or more further embodiments, light capturing ribbon is used to increase solar cell efficiency. Light capturing ribbons are commercially available from several interconnecting wire manufacturers. FIG. 6 generally illustrates how light capturing ribbon works. The term ribbon usually refers to flat wires used to interconnect solar cells. However, in this case, the term ribbon refers to the particular shape of the top surface of the wire that allows for incident light to be reflected off the ribbon and be generally totally internally reflected such that this light is now incident on the solar cells and not lost because of the usual shadowing effect of the busbars. Use of light capturing ribbon can provide a 2-3% gain in efficiency.

FIG. 7 illustrates one example of the use of light capturing ribbon on a solar cell 700 in accordance with one or more embodiments. The light capturing ribbon 702 includes bent portions at the ends of the ribbons that are to be attached to the rear of an adjacent solar cell. However, the very advantage of this light capturing ribbon can become a disadvantage when it comes to contacting the rear of an adjacent cell, as there is now no flat surface of the ribbon to solder the ribbon onto the rear of the cell. However, this problem is obviated in accordance with one or more embodiments, as the lower, flat surface of the light capturing ribbon can be bonded to the wires on the lower perform sheet by either method 1 or 2 detailed above. Only a very short section of the ribbon will extend beyond the cell (e.g., a few mm) in order to meet the flat wires that are part of the lower preform on the ionomer sheet.

Note that FIG. 6 mentions use of EVA as the encapsulant material. As discussed above, various embodiments described herein instead utilize ionomer and acid copolymer blends because these materials have high melt strength that allows the attached interconnecting strips to be accurately and firmly positioned and bonded even while in a molten state.

One or more further embodiments are directed to incorporating the wider wires (those of about 1 cm in width) used to connect the cell strings onto the performs. These wires are coated with the appropriate material (e.g., either the low temperature solder paste or the conductive adhesive). In this way, the module is completed after lamination, and does not require further interconnection wiring.

One or more further embodiments are directed to incorporating bypass diodes onto the wide connecting wires described above. In conventional modules, bypass diodes can be incorporated into the junction box on the rear of the module. These diodes should be heat sunk and are therefore usually placed in the junction box. However, it has been shown that heat sinking these diodes when they are in a flat configuration can be performed using the wide interconnecting wires. The width (about 1 cm in width) and length of the wires allow heat sinking to be successfully performed. Such a technique has been used by some manufacturers of solar cell modules. In one or more embodiments, bypass diodes are incorporated onto the wide (about 1 cm in width) connecting wires that are on the preforms.

A hybrid PVT module combines electrical output form solar cells with a fluid circuit behind the cells to extract the heat generated in the module. In accordance with one or more embodiments, the lower preform material used in a PVT module can comprise a three layer laminate structure. The laminate structure can include ionomer or a similar embodiment on the inner surface contacting the solar cell, a thin aluminum foil layer or a similar barrier layer to prevent moisture from reaching the solar cell portion of the PVT module, and a layer of another polymer used as a bonding layer to the thermal portion of the module.

Methods for interconnecting solar cells in accordance with one or more embodiments can also be applied to back-contacted solar cells. Back-contacted solar cells are a type of crystalline solar cells now commercially available that have all their contacts on the rear of the solar cells. There are three main types of back-contact solar cells: back junction (BJ), emitter wrap-through (EWT), and metallization wrap through (MWT). Methods in accordance with various embodiments can be applied to each of these types of back-contact cells where all the contacts will be formed on a single rear sheet of ionomer that can be bonded to the backskin material. In such a case, the contact pattern could be designed for the particular cell and be different depending on whether it is a BJ, EWT, or MWT type of cell.

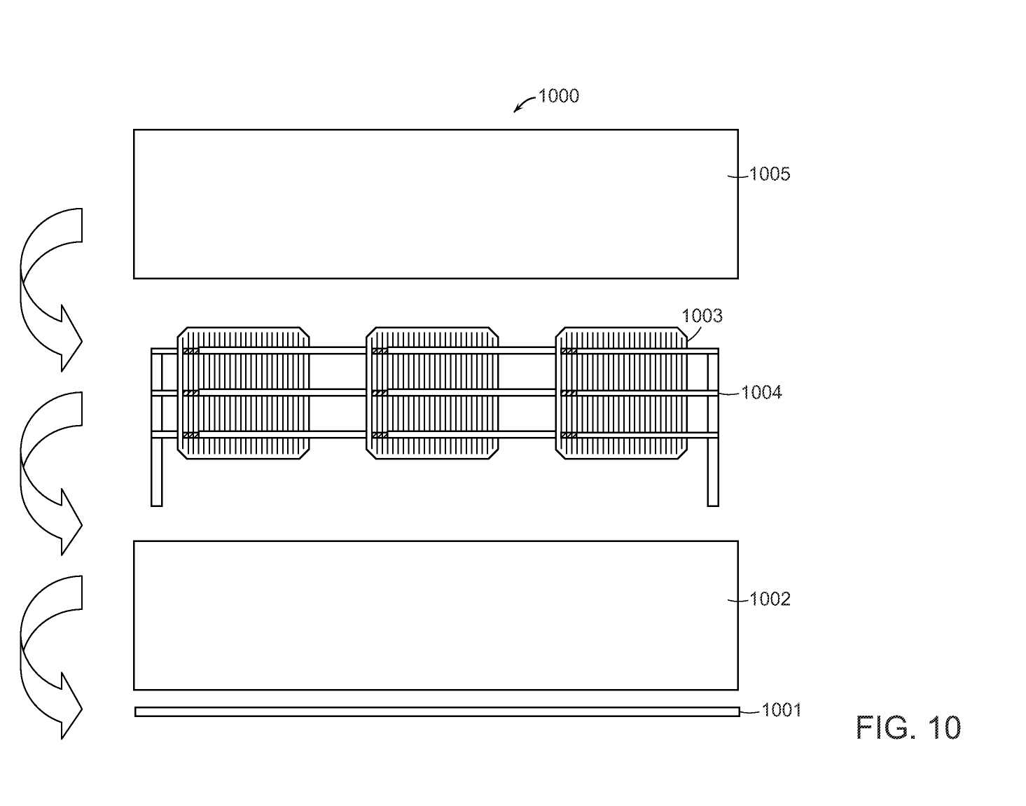

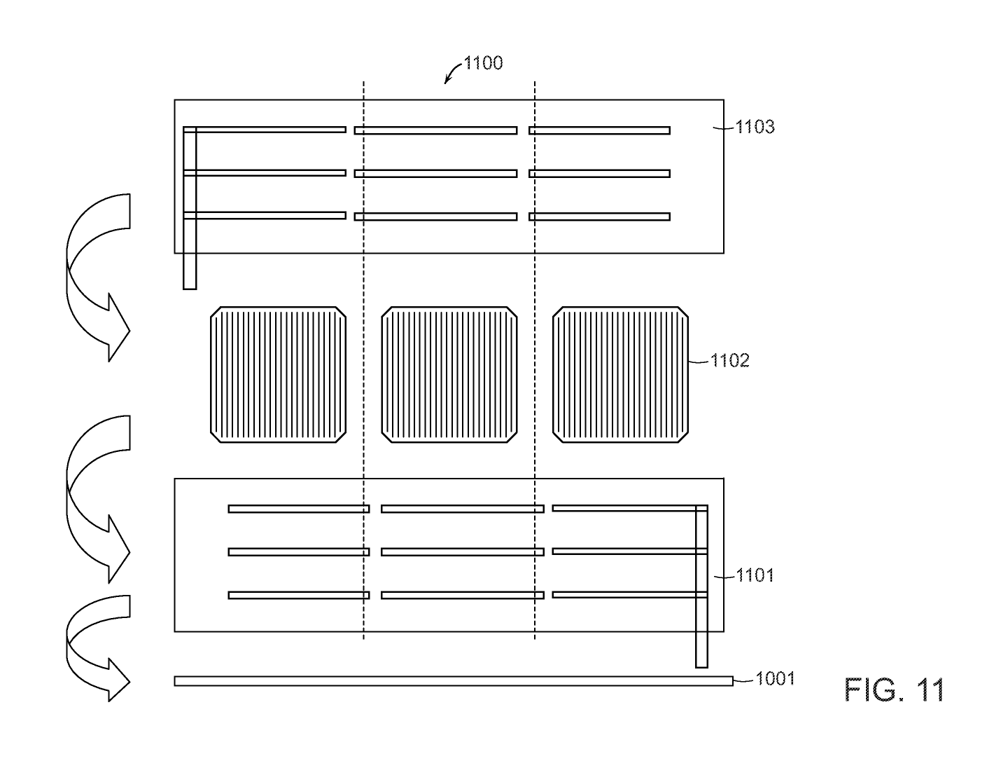

FIG. 10 shows a conventional setup for a lamination process. The layers 1000 are assembled on top of each other prior to the lamination step. A first layer 1001 is a typically a glass sheet. A second layer 1002 (“front sheet”) is an encapsulant such as EVA or lonomer. A third layer comprises a plurality of solar cells 1003 interconnected by copper wires 1004 in a conventional lamination process.

Methods for interconnection solar cells in accordance with one or more embodiments can be seen in FIG. 11. The glass layer 1001 is now covered by the first preform 1101, followed by a plurality of solar cells 1102 and a second preform 1103.

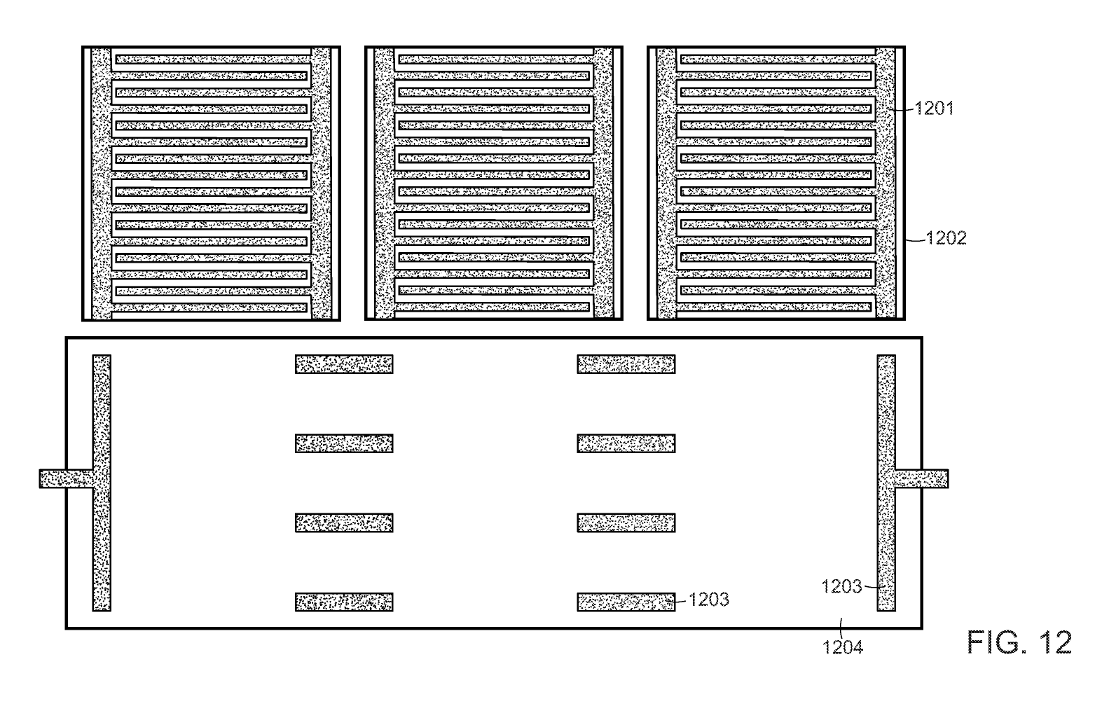

Backside contact solar cells can also be laminated using methods in accordance with various embodiments. In FIG. 12 a simplified view is shown of an exemplary backside, edge contact interdigitated solar cell lamination process. The solar cells 1202 have contacts 1201 on opposite edges of the cell, so that the preform comprising the encapsulant 1204 and the wires 1203 can be relatively simple. Since the solar cells only have contacts on the rear, the front side preform can simply be an encapsulant such as lonomer.

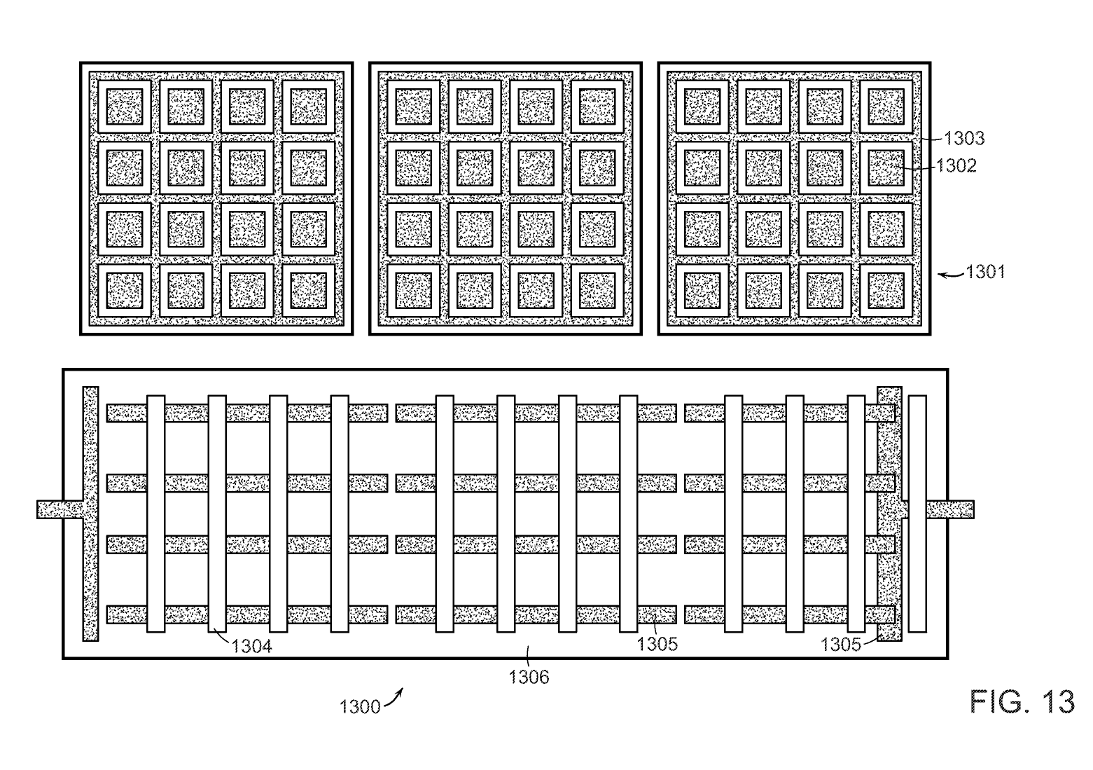

An alternate exemplary backside contact structure is shown in FIG. 13. The solar cells 1301 in this example have island-shaped contacts at the rear of the cells. The back side island contacts 1302 with the grid edge contact 1303 need to be interconnected. A preform 1300 has an encapsulant 1306 with wires 1305 connected in such a way as to contact the islands on the rear of the cells as well as the grid of the previous cell. In order to inhibit electrical contacts in undesired locations, additional insulators 1304 can be applied in a pattern suitable to prevent connections to the grid contacts.

Test Results: Methods in accordance with various embodiments have been tested on small modules having three cells and the top and bottom preforms as described above. Lamination was done in a commercial laminator with a set temperature of 150 degrees Celsius in a cycle of about 15 minutes. Three such modules were made. In one case, a low temperature solder was coated onto the flat wires on the preforms. In another case, a conductive adhesive coating was placed on the flat wires on the preforms. In the third case, using low temperature solder, the top preform was deliberately misaligned such that it contacted only the fingers on the solar cell but not the busbar. In all three cases, a functioning solar cell module was formed, confirming feasibility of the methods. Additionally, the last of the three cases demonstrates the feasibility of eliminating the need for top busbars on the solar cells.

Accordingly, in one or more further embodiments, solar cells that are interconnected by the methods disclosed herein do not include top busbars. Interconnection of solar cells is achieved by placing the wires in the preforms in contact with fingers or other conductive structures on the solar cells such as spider-shaped conductors. There are several advantages to eliminating the busbars on the solar cells, including reduced usage of metal pastes, which lowers manufacturing costs. In addition, eliminating busbars can reduce film induced wafer bowing, allowing easier manufacturing. Wafer bowing is particularly a problem when utilizing very thin solar cells, which warp more easily. Furthermore, eliminating busbars can reduce alignment problems between the wires on the preforms and the cells. Use of front side busbars can increase small misalignments, which can result in additional shading.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Having described preferred embodiments of the present invention, it should be apparent that modifications can be made without departing from the spirit and scope of the invention.

What is claimed is:

1. A method for electrically interconnecting solar cells in a solar module, comprising the steps of:
(a) providing a plurality of solar cells;
(b) providing an upper preform and a lower preform, each comprising a sheet of ionomer encapsulant material having wires to be used for interconnecting the solar cells, said wires being bonded to an inner surface of each preform;
(c) positioning the solar cells between the inner surfaces of the upper and lower preforms such that each wire on a preform includes a portion proximal to a contact area on one of the solar cells and another portion proximal to a contact area of a wire on the other preform; and
(d) laminating the upper and lower preforms together such that each wire becomes securely connected to another wire and to a solar cell at respective contact areas to electrically interconnect adjacent solar cells.

2. The method of claim 1, wherein surfaces of the wires are coated with a low temperature solder paste that melts at about 150 degrees Celsius or less and that forms an electrical interconnection as a result of the temperature and pressure conditions resulting from the laminating step.

3. The method of claim 2 wherein the low temperature solder paste comprises bismuth solder paste.

4. The method of claim 1, wherein surfaces of the wires are coated with a B stage conductive adhesive that sets at temperatures of about 150 degrees Celsius or less.

5. The method of claim 4, wherein the solar cells are interconnected when the B stage conductive adhesive cures at temperature and pressure conditions resulting from the laminating step.

6. The method of claim 4, wherein the conductive adhesive comprises a silver filled polymer that melts at less than 150 degrees Celsius.

7. The method of claim 1, wherein the wires comprises a light-capturing ribbon that causes incident light to be reflected off the ribbon and internally reflected within the photovoltaic module such that the light reflected off the ribbon is incident on the solar cells.

8. The method of claim 1, wherein the lower preform comprises a co-polymer of ethylene and either acrylic acid neutralized with a cation or methacryclic acid neutralized with a cation.

9. The method of claim 1, wherein the lower perform comprises a blend of an ionomer and another polymer.

10. The method of claim 9, wherein said another polymer comprises nylon.

11. The method of claim 1, wherein the lower preform is adapted for use in a hybrid PVT module, said lower preform comprising a three-layer laminate structure with an ionomer forming the inner surface of the preform, a polymer to be bonded to a thermal portion of the hybrid PVT module, and a barrier layer between the ionomer and the polymer.

12. The method of claim 11, wherein the barrier layer comprises a thin aluminum foil layer.

13. The method of claim 1, wherein each of the solar cells includes a conductive structure forming the contact areas for the wires on the upper preform.

14. The method of claim 13, wherein the conductive structure comprises a plurality of thin fingers or a spider-shaped conductive structure.

15. The method of claim 1, wherein each of the solar cells includes a plurality of busbars forming the contact areas on the solar cells for the wires on the upper preform.

16. The method of claim 1, wherein the laminating step causes the upper and lower preforms to be heated to temperature less than 150 degrees Celsius and at an applied pressure of approximately 14.7 psi.

17. The method of claim 1, further comprising incorporating wires used for connecting solar cell strings into the preforms.

18. The method of claim 17, further comprising incorporating one or more bypass diodes into the wires used for connecting solar cell strings.

19. A method for electrically interconnecting solar cells in a solar module, comprising the steps of:
(a) providing a plurality of back-contacted solar cells:
(b) providing an upper preform and a lower preform, each comprising a sheet of ionomer encapsulant material, wherein the lower preform includes wires to be used for interconnecting the solar cells, said wires being bonded to an inner surface of the lower preform;
(c) positioning the solar cells between the upper and lower preforms such that each wire on the lower preform includes a portion proximal to a contact area on a back surface of one of the solar cells and another portion proximal to a contact area on a back surface of an adjacent solar cell; and
(d) laminating the upper and lower preforms together such that each wire becomes securely connected to a solar cell and an adjacent solar cell at respective contact areas to electrically interconnect the solar cells.

20. The method of claim 19, wherein surfaces of the wires are coated with a low temperature solder paste that melts at about 150 degrees Celsius or less and that effects an electrical interconnection resulting from temperature and pressure conditions during the laminating step.

21. The method of claim 20, wherein the low temperature solder paste comprises bismuth solder paste.

22. The method of claim 19, wherein surfaces of the wires are coated with a B stage conductive adhesive that sets at temperatures of about 150 degrees Celsius or less.

23. The method of claim 22, wherein the solar cells are interconnected when the B stage conductive adhesive cures at temperature and pressure conditions resulting from the laminating step.

24. The method of claim 22, wherein the conductive adhesive comprises a silver filled polymer that melts at less than 150 degrees Celsius.

25. The method of claim 19, wherein the lower preform comprises a co-polymer of ethylene and either acrylic acid neutralized with a cation or methacryclic acid neutralized with a cation.

26. The method of claim 19, wherein the lower perform comprises a blend of an ionomer and another polymer.

27. The method of claim 26, wherein said another polymer comprises nylon.

28. The method of claim 19, wherein the lower preform is adapted for use in a hybrid PVT module, said lower preform comprising a three-layer laminate structure with an ionomer forming the inner surface of the preform, a polymer to be bonded to a thermal portion of the hybrid PVT module, and a barrier layer between the ionomer and the polymer.

29. The method of claim 28, wherein the barrier layer comprises a thin aluminum foil layer.

30. The method of claim 19, wherein the laminating step causes the upper and lower preforms to be heated to temperature less than 150 degrees Celsius and at an applied pressure of approximately 14.7 psi.

31. The method of claim 19, further comprising incorporating wires used for connecting solar cell strings into the preforms.

32. The method of claim 31, further comprising incorporating one or more bypass diodes into the wires used for connecting solar cell strings.
